(19) United States
(12) Patent Application Publication
(10) Pub. No.: US 2004/0224726 A1
(43) Pub. Date: Nov. 11, 2004

(54) Method and apparatus for a programmable hand held multi-media device

(76) Inventor: Fathy Yassa, Soquel, CA (US)

Correspondence Address: Fathy Yassa, 4439 Esta Lane, Soquel, CA, 95073, US

(21) Appl. No.: 10/776,630

(22) Filed: Feb. 9, 2004

Related U.S. Application Data
(60) Provisional application No. 60/446,435, filed on Feb. 12, 2003.

(51) Int. Cl. H04M 1/00

(52) U.S. Cl. 455/566; 455/556.1; 455/556.2

(57) ABSTRACT

A novel and exemplary hand held multimedia device.

### PRIORITY CLAIM

This Application claims priority from USPTO provisional application No. 60/446,435 filed on Feb. 12, 2003 and incorporates said application by reference as if fully set forth herein. This application also incorporates by reference the applications entitled METHOD AND APPARATUS FOR EXTENDING THE FUNCTIONALITY OF OFF-LINE WIRELESS DEVICE STORAGE FOR WIRLESS MULTI-MEDIA DEVICES and METHOD AND APPARATUS TO ADD FUNCTIONALITY TO GAMING DEVICES both filed contemporaneously with this instant application.

### FIELD OF THE INVENTION

The invention disclosed herein describes an exemplary hand held wireless device that can obtain content and programming from any number of external sources.

### BACKGROUND

Electronic hand held device arose out of the need for portable functionality. The first earliest electronic hand held devices were calculators, simple machines confined to the basic arithmetic functions. The earliest electronic hand held devices tended to be big and bulky, minimal memory if any, non-upgradeable with hard-wired functions, and limited output or display capabilities.

The advent of the microprocessor permitted a second generation of electronic hand held devices which included calculators with sophisticated algebraic functions, graphing calculator, electronic address books, word processors, etc. The second generation represented a substantial leap in electronic hand held technology. However, these devices still tended to be bulky, although smaller than the previous generation. Additionally, they tended to be non-upgradeable, with limited display and output capabilities.

The introduction of cellular technology permitted consumers to purchase mobile or cellular phones, permitting consumer greater communications flexibility. The first cell phones were huge by modem standards. They required large components and even larger power supplies. When introduced, cell phones were more commonly known as car phones since a car battery was the only mobile power source sufficient to power an early model mobile phone.

As components became less power hungry, and display units increased in resolution, and decreased in cost, some of the older technology was re-introduced into an integrated package known as a personal digital assistant or PDA for short. A PDA combined the functionality of a calculator, address book, miniature office suite of programs, and oftentimes a game or other mental diversion. The second generation of PDAs incorporated most of the feature functionality of a computer including expanded RAM, larger displays, etc. Some common examples include Honeywell's WebPad, commonly known as an internet appliance, and Tablet PC's. The common difference between these second generation PDA's and a traditional personal computer is that these second generation PDA's have very limited storage capacity by contrast. Most do not have hard drives, relying on the smaller capacity flash memory cards for storage.

The limitation of these devices is that they are centered on the personal computer model. They fail to exploit the power of the wi-fi connection which in its current embodiment can transmit at a theoretical limit of 54 megabits per second. All of the wi-fi capacities are designed to receive data from a server via the internet.

The invention herein disclosed represents a novel and exemplary hand held device for streaming audio and video from plurality of devices which are not connected to the internet or personal computer.

### BRIEF DESCRIPTION OF THE DRAWINGS

FIG. 1 illustrates one conceptual embodiment of the device.

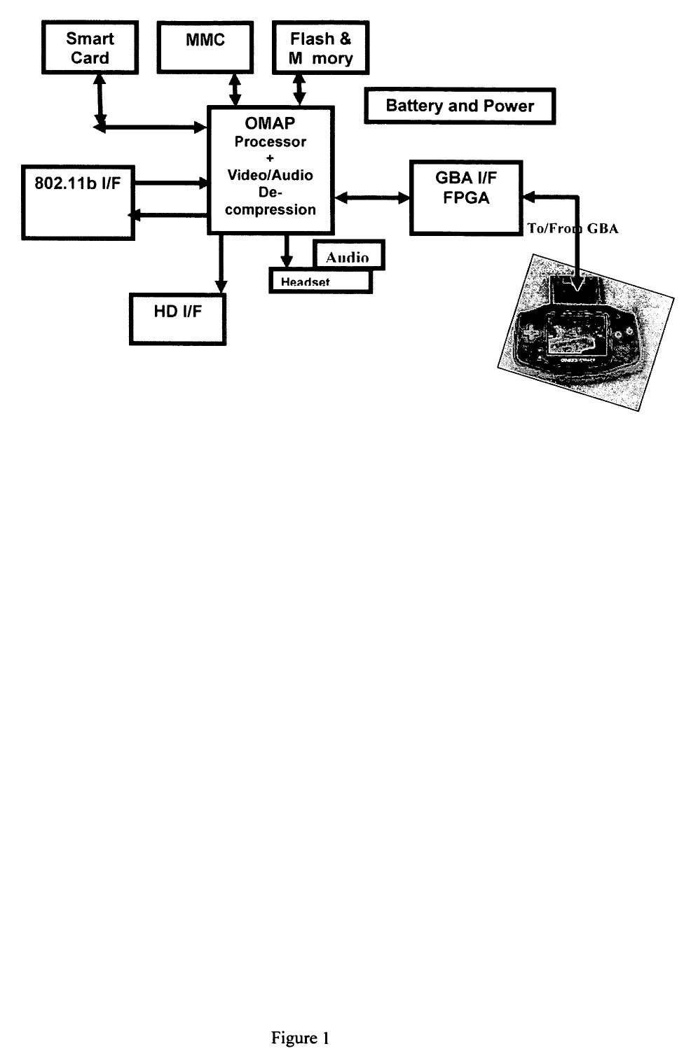

FIG. 2 illustrates one schematic embodiment of the device.

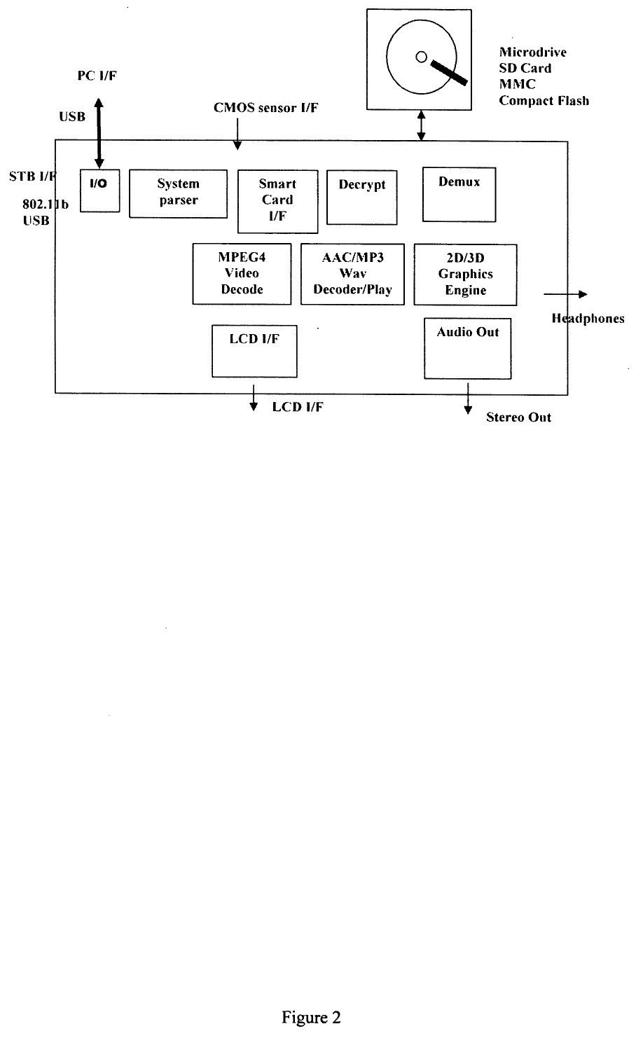

### DETAILED DESCRIPTION OF THE EMBODIMENTS

The device herein discloses improves upon the current state of the art technology by creating a wireless, programmable, multi-media device that can receive and send information to a non-pc, non-server based, and non-internet device. In one embodiment of the invention, the invention consists of ROM, sufficient RAM to download programs or multi-media content, a microprocessor, a display screen large enough for multi-media viewing, module configured for mass storage, and a wireless connection with sufficient bandwidth to download or stream content, and a module for entering commands such as a keyboard. In a further embodiment, the invention includes multiple wireless connections.

In one embodiment of the invention, the mass storage device is a micro-drive with sufficient capacity to hold both downloaded programs and multi-media content. In another embodiment of the invention, the mass storage device is a memory stick such as a smart media card. In yet another embodiment of the invention, the mass storage device is not physically connected to the device but communicates wirelessly thus increasing the potential size of the mass storage device, to wit: it no longer needs to fit inside the wireless device. Said mass storage device can be any device capable of storing data such as a DVD player, a personal video recorder. The only limitation is that said external device is configured with a channel for wireless control and a channel for wireless data transmission. Said channel may be the same or distinct. Said channels may also use different wireless protocols

In embodiment of the invention, one or more of the wireless modules are configured with wi-fi capabilities. Currently wi-fi is commonly known as 802.11 b which has a theoretical speed on 11 megabits per second (mps) and a practical speed of 3-5mps. Wi-fi is also known as 802.11 g which has an upper theoretical speed of 54 mps, and a practical speed of between 15 and 20 mps.

In another embodiment of the invention, the invention further equipped with a second wi-fi connector. In a further embodiment of the invention, the invention is further equipped with traditional wireless compatible with one or more technologies such as television signals and traditional infra-red communication.

In yet another embodiment, the invention is equipped with TCP/IP to wit: Transmission Control Protocol / Internet Protocol which are the protocols, or conventions, that computers use to communicate over the Internet.

In yet another embodiment of the invention, as the device is downloading information from one wireless channel, one or more of its remaining wireless channels is used to send the data to a wireless remote mass storage device.

We claim:

1. A wireless devices comprising a microprocessor, ROM, RAM, a mass storage device, a display unit with sufficient resolution to display multi-media, software, a module for entering keyed commands, and one or more wireless modules configured to communicate with non-internet based wireless devices.

2. The device of claim 1, where the mass storage device is not physically connected to the device.

3. The device of claim 1, where the mass storage device is not connected to a personal computer.

4. The device of claim 1, where the mass storage device is not connected to a wide area global network.

5. The device of claim 1, where the mass storage device can send and receive information wirelessly.

6. The device of claim 5, where the mass storage device has one wireless module for data and another for commands.

7. The device of claim 5, where one wireless module includes wi-fi.

8. The device of claim 5, where at least one wireless module is a traditional wireless module.

9. The device in claim 1, where the device can operate on two separate wi-fi channels.

10. The device as in claim 9, where the device can receive data on one wi-fi channel and send it to another wi-fi device using a second wi-fi channel.

11. The device as in claim 9, where the device translated the data into a form useable by the mass storage device.
